(19) United States
(12) Patent Application Publication
(10) Pub. No.: US 2026/0188003 A1
(43) Pub. Date: Jul. 2, 2026

(54) COMMUNICATION SYSTEM AND METHOD BASED ON AUGMENTED REALITY AND COMPUTING DEVICE FOR EXECUTING THE SAME

(71) Applicant: UNIVERSITY-INDUSTRY COOPERATION GROUP OF KYUNG HEE UNIVERSITY, Gyeonggi-do (KR)

(72) Inventors: CHOONG SEON HONG, Gyeonggi-do (KR); DANG TRI NGUYEN, Gyeonggi-do (KR); SEONG BAE PARK, Seoul (KR); JI SU YOON, Gyeonggi-do (KR); KI TAE KIM, Gyeonggi-do (KR); XUAN LOC NGUYEN, Gyeonggi-do (KR)

(21) Appl. No.: 19/130,227

(22) PCT Filed: Nov. 14, 2023
(86) PCT No.: PCT/KR2023/018313

§ 371 Date: May 15, 2025

(30) Foreign Application Priority Data
Nov. 15, 2022 (KR) 10-2022-0152732
Jan. 2, 2023 (KR) 10-2023-0000387

(51) Int. Cl. G06V 20/20; G06V 10/70; G06V 10/82; G06V 10/94; G06V 20/62; H04W 28/06

(52) U.S. Cl. CPC G06V 20/20; G06V 10/768; G06V 10/82; G06V 10/95; G06V 20/63; H04W 28/06

(57) ABSTRACT

A communication system based on augmented reality includes a user terminal which extracts semantic information from an actual environmental image, and transmits an augmented reality content request comprising the extracted semantic information, and a base station device which receives the augmented reality content request, and transmits an object rendered to the user terminal according to whether the object is recognized based on the semantic information comprised in the augmented reality content request.

### SPONSORED RESEARCH AND DEVELOPMENT

National research and development program supporting this invention (1)
Project identification number: 1711194179
Project number: 00207816
Ministry name: Ministry of Science and ICT
Project management (specialized) institute name: National Research Foundation of Korea
Research program name: Group Research Support
Research project name: Development of Core Structure of Satellite-Air-Ground Integrated Networking System Based on Meta Federated Learning
Contribution ratio: 1/4
Project performing agency name: Industry Academic Cooperation Foundation of Kyunghee University
Research period: Mar. 1, 2023-Feb. 29, 2024
National research and development program supporting this invention (2)
Project identification number: 1711193491
Project number: 2019-0-01287-005
Ministry name: Ministry of Science and ICT
Project management (specialized) institute name: Institute of Information & Communications Technology Planning & Evaluation
Research program name: SW Computing Industry Source Technology Development
Research project name: (SW Starlab) Evolvable Deep Learning Model Generation Platform for Edge Computing
Contribution ratio: 1/4
Project performing agency name: Industry Academic Cooperation Foundation Of Kyunghee University
Research period: Jan. 1, 2023-Dec. 31, 2023
National research and development program supporting this invention (3)
Project identification number: 1711193622
Project number: 2021-0-02068-003
Ministry name: Ministry of Science and ICT
Project management (specialized) institute name: Institute of Information & Communications Technology Planning & Evaluation
Research program name: Cultivating Innovative Professionals for Information and Communication Broadcasting
Research project name: Artificial Intelligence Innovative Hub
Contribution ratio: 1/4
Project performing agency name: Korea University Research and Business Foundation
Research period: Jan. 1, 2023-Dec. 31, 2023
National research and development program supporting this invention (4)
Project identification number: 1415186550
Project number: 20209810400030
Ministry name: Ministry of Trade, Industry and Energy
Project management (specialized) institute name: Korean Institute of Energy Technology Evaluation and Planning
Research program name: Energy New Technology Standardization and Certification Support Project
Research project name: Electric Vehicle PnC-based Charging Service, Security authentication system establishment
Contribution ratio: 1/4
Project performing agency name: Korea Electrotechnology Research Institute
Research period: Jan. 1, 2023-Apr. 30, 2023

### BACKGROUND

### 1. Technical Field

Examples of the present invention are related to augmented reality-based communication technology.

### 2. Background Art

In the next-generation communication network, augmented reality (AR) is expected to be an application mainly used in infotainment services. In the AR-based services, users can experience AR contents in a way that 3D objects generated based on the actual environment and related information are displayed on smart glasses or smart phones, or the like. An increase in data computation and data traffic will follow in providing AR-based services.

Therefore, in the communication system providing AR-based services, to meet such requirements, a significant amount of communication and computing resources are required. Accordingly, in order to smoothly provide AR-based services, a method for minimizing network traffic is required.

### SUMMARY

Examples disclosed are to provide a communication system and a communication method based on augmented reality that can minimize network traffic and a computing device for performing the same.

The communication system based on augmented reality according to one example disclosed includes a user terminal which extracts semantic information from an actual environmental image, and transmits an augmented reality content request including the extracted semantic information; and a base station device which receives the augmented reality content request, and transmits an object rendered to the user terminal according to whether the object is recognized based on the semantic information included in the augmented reality content request.

The user terminal may include an image acquisition module that acquires an actual environmental image; an artificial neural network module that receives the actual environmental image as input, and extracts semantic information from the actual environmental image; and a communication module that transmits the semantic information output by the artificial neural network module to the base station device.

The artificial neural network module, may include a first machine learning model which receives the actual environmental image as input, and is learned to extract a semantic image from the actual environmental image; and a second machine learning model which receives the actual environmental image as input, and is learned to extract a semantic text from the actual environmental image, and the communication module, may transmit the semantic image or the semantic text to the base station device.

The user terminal, may further include a determination module which determines semantic information to be transmitted to the base station device among the semantic image output from the first machine learning model and the semantic text output from the second machine learning model, and the communication module, may transmit the semantic information determined by the determination module to the base station device.

The determination module, may determine semantic information to be transmitted to the base station device based on at least one of a data reduction amount compared to the actual environmental image and the processing waiting time of the semantic information.

The determination modules, may calculate a first data reduction amount by a difference between the data size of the actual environmental image and the data size of the semantic image, calculate a second data reduction amount by a difference between the data size of the actual environmental image and the data size of the semantic text, calculate a first processing waiting time taken to extract the semantic image from the actual environmental image, calculate a second processing waiting time taken to extract the semantic text from the actual environmental image, and determine semantic information to be transmitted to the base station device by comparing the first data reduction amount and the first processing waiting time related to the semantic image, and the second data reduction amount and the second processing waiting time related to the semantic text.

The determination module, may give weights different from each other to the data reduction amount and the processing waiting time depending on the network situation between the user terminal and the base station device and the computing resource situation of the user terminal.

The determination module, may give a higher weight to the data reduction amount than the processing waiting time, when the network situation between the user terminal and the base station device is at the pre-set level or less, and give a higher weight to the processing waiting time than the data reduction amount, when the computing resource situation of the user terminal is at the pre-set level or less.

The base station device, may transmit an object recognition failure message to the user terminal, when an object cannot be recognized based on semantic information included in the augmented reality content request, and the user terminal, may transmit other semantic information other than the previously transmitted semantic information to the base station device.

The communication method based on augmented reality according to one example disclosed, is a method performed in a computing device equipped with one or more processors, and a memory storing one or more programs executed by the one or more processors, and includes acquiring an actual environmental image; extracting semantic information form the actual environmental image based on an artificial neural network; transmitting an augmented reality content request including the extracted semantic information to a base station device; and receiving an object rendered according to whether an object is recognized based on the semantic information from the base station device.

The extracting semantic information, may include inputting the actual environmental image to a pre-learned first machine learning model to extract a semantic image from the actual environmental image; and inputting the actual environmental image to a pre-learned second machine learning model to extract a semantic text from the actual environmental image, and the transmitting semantic information, may transmit the semantic image or the semantic text to the base station device.

The communication method based on augmented reality, may further include determining semantic information to be transmitted to the base station device among the semantic image output from the first machine learning model and the semantic text output from the second machine learning model.

The determining, may determine semantic information to be transmitted to the base station device based on at least one of the data reduction amount compared to the actual environmental image and the processing waiting time of the semantic information.

The determining, may include calculating a first data reduction amount by a difference between the data size of the actual environmental image and the data size of the semantic image; calculating a second data reduction amount by a difference between the data size of the actual environmental image and the data size of the semantic text; calculating a first processing waiting time taken to extract the semantic image from the actual environmental image; calculating a second processing waiting time taken to extract the semantic text from the actual environmental image; and determining semantic information to be transmitted to the base station device by comparing the first data reduction amount and the first processing waiting time related to the semantic image, and the second data reduction amount and the second processing waiting time related to the semantic text.

The determining, may include giving weights different from each other to the data reduction amount and the processing waiting time depending on the network situation between the user terminal and the base station device and the computing resource situation of the user terminal.

The giving weights, may give a higher weight to the data reduction amount than the processing waiting time, when the network situation between the user terminal and the base station device is at the pre-set level or less, and give a higher weight to the processing waiting time than the data reduction amount, when the computing resource situation of the user terminal is at the pre-set level or less.

The communication method based on augmented reality may further include receiving an object recognition failure message from the base station device, when an object cannot be recognized based on semantic information; and transmitting other semantic information other than the previously sent semantic information to the base station device.

The communication method based on augmented reality according to other example disclosed, is a method performed in a computing device equipped with one or more processors, and a memory storing one or more programs executed by the one or more processors, and includes receiving an augmented reality content request including semantic information extracted from an actual environmental image from a user terminal; identifying whether an object can be recognized based on the semantic information included in the augmented reality content request; rendering the recognized object, when the object can be recognized; and transmitting the rendered object is transmitted to the user terminal.

The computing device according to one example disclosed, includes one or more processors; a memory; and one or more programs, and is configured for the one or more programs to be stored in the memory and be executed by the one or more processors, and the one or more programs, include an instruction for acquiring an actual environmental image; an instruction for extracting semantic information from the actual environmental image based on an artificial neural network; an instruction for transmitting an augmented reality content request including the extracted semantic information to an external device; and an instruction for receiving a rendered object according to whether an object is recognized based on the semantic information from the external device.

The computing device according to one example disclosed, includes one or more processors; a memory; and one or more programs, and is configured for the one or more programs to be stored in the memory and be executed by the one or more processors, and includes an instruction for receiving an augmented reality content request including semantic information extracted from an actual environmental image from a user terminal; an instruction for identifying whether an object can be recognized based on the semantic information included in the augmented reality content request; an instruction for rendering the recognized object, when the object can be recognized; and an instruction for transmitting the rendered object to the user terminal.

According to the disclosed examples, by transmitting semantic information extracted from an actual environmental image instead of the actual environmental image to a base station device in a user terminal, network traffic can be reduced during providing services based on augmented reality, and due to this, augmented reality-based services can be smoothly provided.

### BRIEF DESCRIPTION OF THE DRAWINGS

FIG. 1 is a diagram showing the communication system based on augmented reality according to one example of the present invention.

FIG. 2 is a diagram schematically showing the state in which a user terminal extracts a semantic image from an actual environmental image and transmits the extracted semantic image to a base station device in one example of the present invention.

FIG. 3 is a diagram schematically showing the state in which a user terminal extracts a semantic text from an actual environmental image and transmits the extracted semantic text to a base station device in one example of the present invention.

FIG. 4 is a block diagram showing the configuration of the user terminal according to one example of the present invention.

FIG. 5 is a diagram showing the actual environmental image and the semantic image extracted from the actual environmental image in one example of the present invention.

FIG. 6 is a flow chart for describing the communication method based on augmented reality according to one example of the present invention.

FIG. 7 is a block diagram for illustrating and explaining a computing environment including a computing device suitable for use in exemplary examples.

### DETAILED DESCRIPTION

Hereinafter, specific embodiments of the present invention will be described with reference to drawings. The following detailed description is provided to help a comprehensive understanding of the method, device, and/or system described in the present description. However, these are only examples, and the present invention is not limited thereto.

In describing the example of the present invention, when it is judged that a detailed description of the prior art related to the present invention may unnecessarily obscure the gist of the present invention, the detailed description will be omitted. In addition, the terms described below are terms defined in consideration of functions in the present invention may vary depending on the intention or practice or the like of the user or operator. Therefore, the definition should be based on the contents throughout the present entire description. The terms used in the detailed description are intended to describe the examples of the present invention only, and should not be limited. Unless used otherwise clearly, singular expressions include meanings of plural expressions. In the present description, expressions such as “comprising” or “equipped” are intended to refer to certain features, numbers, steps, operations, elements, parts or combinations thereof, and they should not be construed to exclude the presence or possibility of one or more other features, numbers, steps, operations, elements, parts of combinations thereof, other than those described.

In the following description, the terms “sending”, “communication”, “transmission”, “receiving” and other terms with similar meanings thereto of signals or information include not only directly transmitting signals or information from one component to another component, but also transmitting via another component. In particular, “sending” or “transmitting” signals or information to one component indicates the final destination of the signals or information, and does not mean the direct destination. This is same even in “receiving” of signals or information. In addition, in the present invention, that two or more data or information is “related” means that at least some of other data (or information) can be obtained based on it, when one data (or information) is obtained.

In addition, the terms of the first, the second, and the like can be used to describe various components, but the components should not be limited by the terms. The terms may be used for the purpose of distinguish one component from other components. For example, without departing from the scope of the present invention, the first component may be named the second component, and similarly, the second component may also be named the first component.

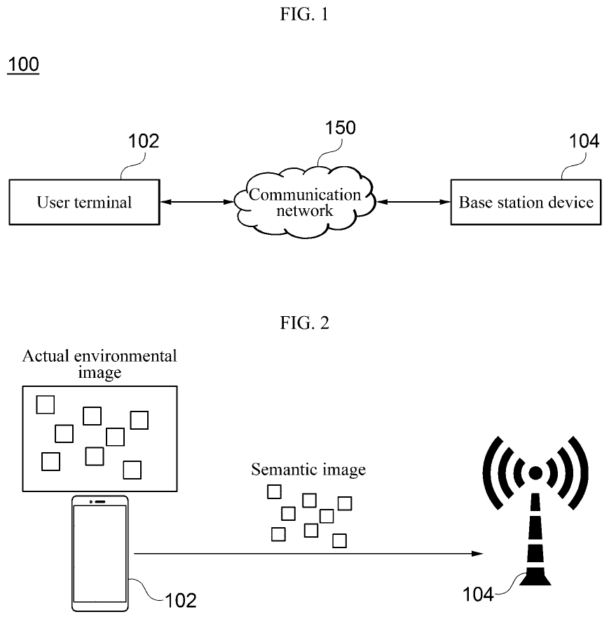

FIG. 1 is a diagram showing the communication system based on augmented reality according to one example of the present invention.

Referring to FIG. 1, the communication system based on augmented reality (100) may include a user terminal (102) and a base station device (104). The user terminal (102) is communicatively connected to the base station device (104) through a communication network (150).

In the examples disclosed, the communication network (150) may include internet, one or more local area networks, wide area networks, cellular networks, mobile networks, other types of networks, or combinations of these networks. The communication network (150) may be a communication environment of 5G or 6G or more, but not limited thereto.

The user terminal (102) may be a terminal of a user using augmented reality (AR)-based services. For example, the user terminal (102) may include electronic devices such as smart phones, tablet PCs, smart glasses, and HMD (Head Mounted Display), and the like.

The user terminal (102) may transmit an augmented reality content request to the base station device (104). In one example, the user terminal (102) may transmit it to the base station device (104) by including an actual environment image which photographs or captures an actual environment in the augmented reality content request. The actual environmental image may be a static image (i.e. image), and may be a video (image having a certain replay time.

The user terminal (102) may not transmit the actual environmental image itself, but transmit it by downscaling the data amount of the actual environmental image to the base station device (104). In one example, the user terminal (102) may extract semantic information from the actual environmental image, and transmit the extracted semantic information to the base station device (104) by including it in the augmented reality content request. The data amount of the semantic information is downscaled than the actual environmental image, so data traffic can be reduced during AR services.

Herein, the semantic information may be a semantic image, and may be a semantic text. The user terminal (102) may extract at least one of a semantic image and a semantic text from the actual environmental image to transmit it to the base station device (104).

FIG. 2 is a diagram schematically showing the state in which a user terminal (102) extracts a semantic image from an actual environmental image and transmits the extracted semantic image to a base station device (104) in one example of the present invention.

Referring to FIG. 2, the user terminal (102) may include a machine learning model that can extract a semantic image an actual environmental image. Herein, the semantic image may be a semantic image feature extracted from the actual environmental image.

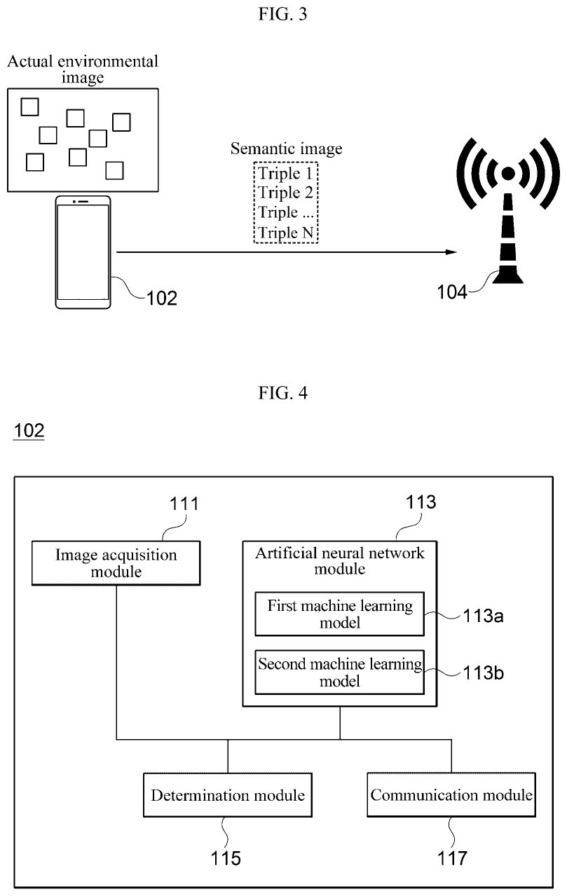

FIG. 3 is a diagram schematically showing the state in which a user terminal (102) extracts a semantic text from an actual environmental image and transmits the extracted semantic text to a base station device (104) in one example of the present invention.

Referring to FIG. 3, the user terminal (102) may include a machine learning model that can extract a semantic text from an actual environmental image. Herein, the semantic text may mean one or more triple sets that explain an actual environmental image or an object included in the actual environmental image. Herein, the triple may consist of a pair of subject, predicate, and object.

The base station device (104) may transmit semantic information from the user terminal (102). The base station device (104) may determine whether a specific object can be recognized on the basis of the received semantic information. When a specific object can be recognized based on semantic information, the base station device (104) may transmit the recognized object to the user terminal (102) after 3D rendering with related information. Then, in the user terminal (102), the 3D rendered object may be mapped and displayed on the screen.

When a specific object cannot be recognized on the basis of semantic information, the base station device (104) may transmit an object recognition failure message to the user terminal (102).

On the other hand, it was described herein that the user terminal (102) transmits semantic information to the base station device (104), but not limited thereto, and may transmit it to other various external devices (for example, other user terminals or server computing devices, etc.).

FIG. 4 is a block diagram showing the configuration of the user terminal (102) according to one example of the present invention.

Referring to FIG. 4, the user terminal (102) may include an image acquisition module (111), an artificial neural network module (113), a determination module (115), and a communication module (117).

The image acquisition module (111) may acquire an actual environmental image to be used for augmented reality contents. In one example, the image acquisition module (111) may acquire an actual environmental image through a photographing means (for example, camera) or a scan means, or the like, equipped in the user terminal (102), but not limited thereto, and the actual environmental image pre-stored may be acquired from the memory of the user terminal (102).

The image acquisition module (111) may deliver the actual environmental image to the artificial neural network module (113). In addition, the image acquisition module (111) may deliver information on the data size of the actual environmental image to the determination module (115).

The artificial neural network module (113) is to extract semantic information from the actual environmental image input. The artificial neural network module (113) may include a first machine learning model (113a) and a second machine learning model (113b).

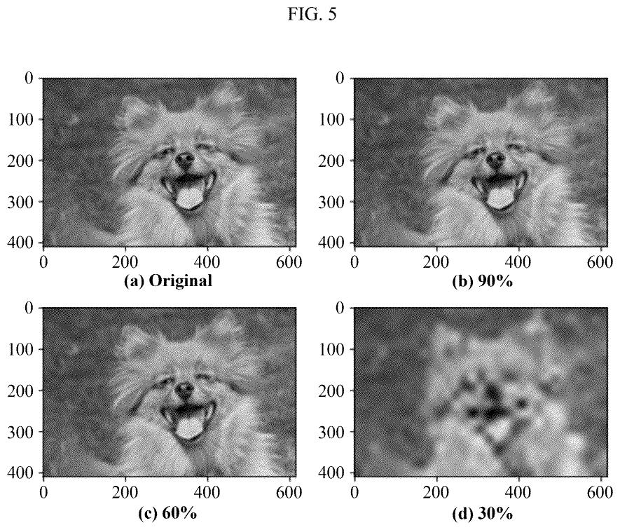

The first machine learning model (113a) may be a model learned to receive the actual environmental image as input, and extract a semantic image from the input actual environmental image. FIG. 5 is a diagram showing the actual environmental image and the semantic image extracted from the actual environmental image in one example of the present invention. Herein, cases where the number of features of the semantic image is 90%, 60%, and 30% were shown.

Referring to FIG. 5, when the number of features of the semantic image is 30%, it is not easy to recognize an object (puppy), but when the number of features of the semantic image is 60%, it may be seen that the object (puppy) is easily recognized. Therefore, when the semantic image is extracted from the actual environmental image, it seems that the object may be recognized at a certain level, if the number of features of the semantic image is approximately 50%, and in this case, the data size of the semantic image corresponds to about 50% of the data size of the actual environmental image, so the data size can be reduced compared to transmitting the actual environmental image.

The second machine learning model (113b) may be a model learned to input the actual environmental image, and extract a semantic text (one or more triples) from the input actual environmental image.

The artificial neural network module (113) may deliver the semantic image output from the first machine learning model (113a) and the semantic text output from the second machine learning model (113b), respectively, to the determination module (115).

The determination module (115) may determine which semantic information among the semantic image and semantic text output from the artificial neural network module (113) is transmitted to the base station device (104). In one example, the determination module (115) may determine semantic information to be transmitted to the base station device (104) based on at least one of the data reduction amount compared to the actual environmental image and processing waiting time.

The determination module (115) may calculate a first data reduction amount through a difference between the data size of the actual environmental image and the data size of the semantic image. The determination module (115) may calculate a second data reduction amount through a difference between the data size of the actual environmental image and the data size of the semantic text.

The determination module (115) may calculate a first processing waiting time taken to extract a semantic image from the actual environmental image through the first machine learning model (113a). The determination module (115) may calculate a second processing waiting time taken to extract a semantic text from the actual environmental image through the second machine learning model (113b).

The determination module (115) may determine semantic information to be transmitted to the base station device (104) by comparing the first data reduction amount and the first processing waiting time related to the semantic image and the second data reduction amount and the second processing waiting time related to the semantic text.

Then, the determination module (115) may give weights different from each other to the data reduction amount and the processing waiting time depending on the network situation between the user terminal (102) and the base station device (104) and the computing resource situation of the user terminal (102).

In one example, when the network situation between the user terminal (102) and base station device (104) is at a pre-set level or less (for example, when the network traffic exceeds the pre-set threshold value, so the network situation becomes worse), the determination module (115) may give a higher weight to the data reduction amount than the processing waiting time.

In addition, when the computing resource situation of the user terminal (102) is at a pre-set level or less (for example, when consumption of computing resources is increased in the user terminal (102), so the computing resource situation becomes worse), the determination module (115) may give a higher weight to the processing waiting time than the data reduction amount.

Furthermore, the determination module (115) may transmit other semantic information other than the previously sent semantic information to the base station device (104) through the communication module (117), when an object recognition failure message is received from the base station device (104), after transmitting a semantic image or semantic text to the base station device (104).

For example, when an object recognition failure message is received from the base station device (104) after transmitting a semantic image to the base station device (104), the determination module (115) may transmit a semantic text to the base station device (104) through the communication module (117).

The communication module (117) is communicatively connected to the base station device (104). The communication module (117) may transmit semantic information (semantic image or semantic text) to the base station device (104) according to the determination of the determination module (115).

According to the example disclosed, by transmitting semantic information extracted from the actual environmental image instead of the actual environmental image in the user terminal (102) to the base station device (104), when providing augmented reality-based services, network traffic can be reduced, and due to this, the augmented reality-based services can be smoothly provided.

In the present specification, the module, may mean functional, structural binding of hardware for performing the technical spirit of the present invention and software to operate the hardware. For example, the “module” may mean a logical unit of a predetermined code and a hardware resource for preforming the predetermined code, and it does not necessarily mean a physically connected code, or mean one type of hardware.

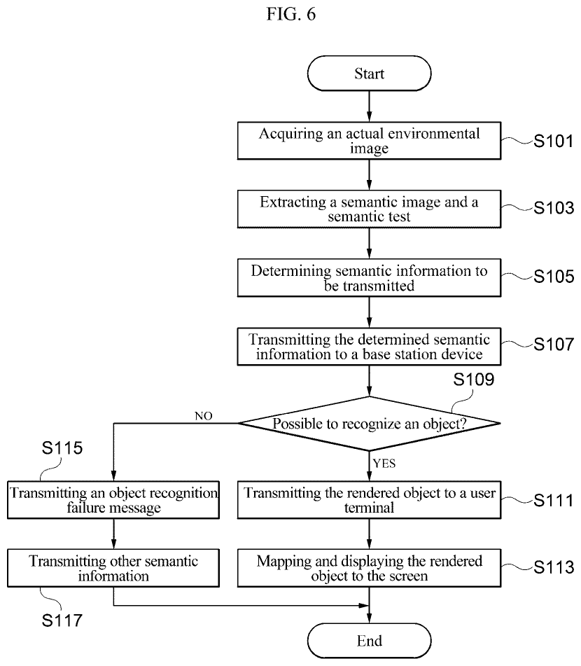

FIG. 6 is a flow chart for describing the communication method based on augmented reality according to one example of the present invention. In the illustrated follow chart, the method is described by dividing into a plurality of steps, but at least some steps may be performed by changing the order, or performed by being combined with other steps, or be omitted, or be performed by dividing into detailed steps, or be performed by adding at least one step not illustrated.

Referring to FIG. 6, the user terminal (102) may acquire an actual environmental image (S 101). Next, the user terminal (102) may input the actual environmental image to the first machine learning model (113a) and the second machine learning model (113b), respectively, and extract a semantic image and a semantic text, respectively (S 103).

Next, the user terminal (102) may determine semantic information to be transmitted among the semantic image and semantic text (S 105). The user terminal (102) may determine semantic information to be transmitted to the base station device (104) based on at least one of the data reduction amount compared to the actual environmental image and processing waiting time.

Then, the user terminal (102) may transmit semantic information determined among the semantic image and semantic text to the base station device (104) (S 107). The user terminal (102) may transmit the determined semantic information to the base station device (104) by including it in the augmented reality content request.

Then, the base station device (104) may identify whether an object can be recognized on the basis of semantic information received from the user terminal (102) (S 109). In other words, the base station device (104) may identify whether an object corresponding to semantic information can be recognized only by semantic information.

As a result of identification of the step S 109, when an object can be recognized, the base station device (104) may render the recognized object and transmit the rendered object to the user terminal (102) (S 111). At this time, the base station device (104) may render the recognized object and related relevant information together.

Next, the user terminal (102) may map and display the rendered object on the screen (S 113). The user terminal (102) may map the rendered object at the corresponding location of the actual environmental image and display it on the screen as an augmented reality content.

As a result of identification of the step S 111, when an object cannot be recognized, the base station device (104) may transmit an object recognition failure message to the user terminal (102) (S 115).

Then, the user terminal (102) may transmit other semantic information other than the previously sent semantic information among the semantic image and the semantic text to the base station device (104) (S 117). However, it is not limited thereto, and the user terminal (102) may transmit the actual environmental image to the base station device (104) depending on the network situation.

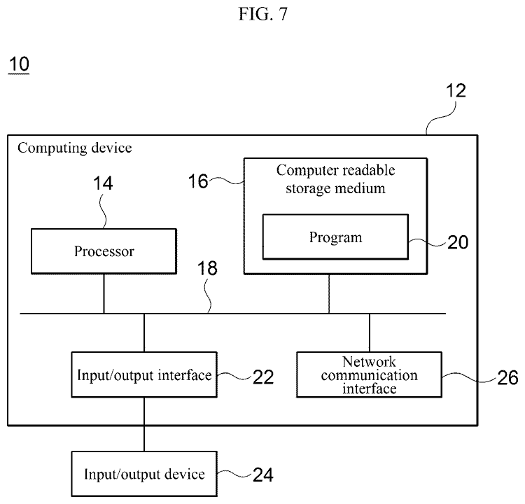

FIG. 7 is a block diagram for illustrating and explaining a computing environment (10) including a computing device suitable for use in exemplary examples. In the illustrated example, each component may have different functions and ability other than those described below, and may include an additional component other than those described below.

The illustrated computing environment (10) includes a computing device (12). In one example, the computing device (12) may be the user terminal (102). In addition, the computing device (12) may be the base station device (104).

The computing device (12) includes at least one processor (14), a computer readable storage medium (16) and a communication bus (18). The processor (14) may allow the computing device (12) to operate according to the exemplary example mentioned above. For example, the processor (14) may execute at least one program stored in the computer readable storage medium (16). The at least one program may include at least one computer executable instruction, and the computer executable instruction may be composed to allow the computing device (12) to perform operations according to the exemplary example, when executed by the processor (14).

The computer readable storage medium (16) is composed to store computer executable instructions or program codes, program data and/or other appropriate forms of information. A program (20) stored in the computer readable storage medium (16) includes a set of executable instructions by the processor (14). In one example, the computer readable storage medium (16) may be a memory (volatile memory such as random access memory, non-volatile memory, or a suitable combination thereof), at least one magnetic disk storage device, optical disk storage devices, flash memory devices, other forms of storage media which can be accessed by other computing device (12) and store desired information, or a suitable combination thereof.

The communication bus (18) interconnects various other components of the computing device (12) by including the processor (14) and computer readable storage medium (16).

The computing device (120) may also include at least one input/output interface (22) and at least one network communication interface (26) which provide interfaces for at least one input/output device (24). The input/output interface (22) and network communication interface (26) are connected to the communication bus (18). The input/output device (24) may be connected to other component of the computing device (12) through the input/output interface (22). The exemplary input/output device (24) may include a pointing device (mouse or trackpad, etc.), a keyboard, a touch input device (touchpad or touchscreen, etc.), a voice and sound input device, various kinds of input devices such as sensor devices and/or photographing devices, and/or an output device such as a display device, a printer, a speaker, and/or a network card. An exemplary input/output device (24) may be included inside the computing device (12) as one component consisting of the computing device (12), and may be connected with the computing device (12) with a separate device distinguished from the computing device (12).

Representative examples of the present invention are described in detail above, but those skilled in the art to which the present invention pertains will understand that various modifications can be made to the afore-mentioned examples within limits without departing from the scope of the present invention. Therefore, the scope of the present invention should not be limited to the examples described, and should be determined by not only claims described later but also equivalents to these claims.

1: A communication system based on augmented reality, comprising:
a user terminal configured to extract semantic information from an actual environmental image, and transmit an augmented reality content request comprising the extracted semantic information; and
a base station device configured to receive the augmented reality content request, and transmit an object rendered to the user terminal according to whether the object is recognized based on the semantic information comprised in the augmented reality content request.

2: The communication system according to claim 1,
wherein the user terminal comprises:
an image acquisition module that acquires an actual environmental image;
an artificial neural network module that receives the actual environmental image as input, and extracts semantic information from the actual environmental image; and
a communication module that transmits the semantic information output by the artificial neural network module to the base station device.

3: The communication system according to claim 2,
wherein the artificial neural network module, comprises:
a first machine learning model which receives the actual environmental image as input, and is learned to extract a semantic image from the actual environmental image; and
a second machine learning model which receives the actual environmental image as input, and is learned to extract a semantic text from the actual environmental image, and
wherein the communication module is configured to transmit the semantic image or the semantic text to the base station device.

4: The communication system according to claim 3,
wherein the user terminal, further comprises:
a determination module configured to determine semantic information to be transmitted to the base station device among the semantic image output from the first machine learning model and the semantic text output from the second machine learning model, and
the communication module configured to transmit, the semantic information determined by the determination module to the base station device.

5: The communication system according to claim 4,
wherein the determination module is configured to determine semantic information to be transmitted to the base station device based on at least one of a data reduction amount compared to the actual environmental image and the processing waiting time of the semantic information.

6: The communication system according to claim 5,
wherein the determination module is configured to:
calculate a first data reduction amount by a difference between the data size of the actual environmental image and the data size of the semantic image;
calculate a second data reduction amount by a difference between the data size of the actual environmental image and the data size of the semantic text;
calculate a first processing waiting time taken to extract the semantic image from the actual environmental image;
calculate a second processing waiting time taken to extract the semantic text from the actual environmental image; and
determine semantic information to be transmitted to the base station device by comparing the first data reduction amount and the first processing waiting time related to the semantic image, and the second data reduction amount and the second processing waiting time related to the semantic text.

7: The communication system according to claim 5,
wherein the determination module, is configured to give weights different from each other to the data reduction amount and the processing waiting time depending on the network situation between the user terminal and the base station device and the computing resource situation of the user terminal.

8: The communication system according to claim 7,
wherein the determination module, is configured to:
give a higher weight to the data reduction amount than the processing waiting time, when the network situation between the user terminal and the base station device is at the pre-set level or less; and
give a higher weight to the processing waiting time than the data reduction amount, when the computing resource situation of the user terminal is at the pre-set level or less.

9: The communication system according to claim 4,
wherein the base station device is configured to transmit an object recognition failure message to the user terminal, when an object cannot be recognized based on semantic information comprised in the augmented reality content request; and
the user terminal is configured to transmit other semantic information other than the previously transmitted semantic information to the base station device.

10: A communication method based on augmented reality, the method performed in a computing device equipped with one or more processors, and a memory storing one or more programs executed by the one or more processors, the communication method comprising:
acquiring an actual environmental image;
extracting semantic information form the actual environmental image based on an artificial neural network;
transmitting an augmented reality content request comprising the extracted semantic information to a base station device; and
receiving an object rendered according to whether an object is recognized based on the semantic information from the base station device.

11: The communication method based on augmented reality according to claim 10,
wherein the extracting of the semantic information comprises:
inputting the actual environmental image to a pre-learned first machine learning model to extract a semantic image from the actual environmental image; and
inputting the actual environmental image to a pre-learned second machine learning model to extract a semantic text from the actual environmental image,
wherein the transmitting of the semantic information comprises transmitting the semantic image or the semantic text to the base station device.

12: The communication method based on augmented reality according to claim 11, further comprising:
determining semantic information to be transmitted to the base station device among the semantic image output from the first machine learning model and the semantic text output from the second machine learning model.

13: The communication method based on augmented reality according to claim 12,
wherein the determining of the semantic information comprises:
determining semantic information to be transmitted to the base station device based on at least one of the data reduction amount compared to the actual environmental image and the processing waiting time of the semantic information.

14: The communication method based on augmented reality according to claim 13,
wherein the determining, of the semantic information comprises:
calculating a first data reduction amount by a difference between the data size of the actual environmental image and the data size of the semantic image;
calculating a second data reduction amount by a difference between the data size of the actual environmental image and the data size of the semantic text;
calculating a first processing waiting time taken to extract the semantic image from the actual environmental image;
calculating a second processing waiting time taken to extract the semantic text from the actual environmental image; and
determining semantic information to be transmitted to the base station device by comparing the first data reduction amount and the first processing waiting time related to the semantic image, and the second data reduction amount and the second processing waiting time related to the semantic text.

15: The communication method based on augmented reality according to claim 13,
wherein the determining of the semantic information comprises:
giving weights different from each other to the data reduction amount and the processing waiting time depending on the network situation between the user terminal and the base station device and the computing resource situation of the user terminal.

16: The communication method based on augmented reality according to claim 15,
wherein the giving of the weights comprises:
giving a higher weight to the data reduction amount than the processing waiting time, when the network situation between the user terminal and the base station device is at the pre-set level or less, and
giving a higher weight to the processing waiting time than the data reduction amount, when the computing resource situation of the user terminal is at the pre-set level or less.

17: The communication method based on augmented reality according to claim 11, further comprising:
receiving an object recognition failure message from the base station device, when an object cannot be recognized based on semantic information; and
transmitting other semantic information other than the previously sent semantic information to the base station device.

18: A communication method based on augmented reality, communication method performed in a computing device equipped with one or more processors, and a memory storing one or more programs executed by the one or more processors, the communication method comprising:
receiving an augmented reality content request comprising semantic information extracted from an actual environmental image from a user terminal;
identifying whether an object can be recognized based on the semantic information comprised in the augmented reality content request;
rendering the recognized object, when the object can be recognized; and
transmitting the rendered object is transmitted to the user terminal.

19. (canceled)

20. (canceled)
